(19) United States
(12) Patent Application Publication
(10) Pub. No.: US 2003/0172155 A1
(43) Pub. Date: Sep. 11, 2003

(54) Cracker tracing system and method, and authentification system and method of using the same

(76) Inventor: Wan-Soo Kim, Seoul (KR)

Correspondence Address: Coleman Sudol Sapone, 714 Colorado Avenue, Bridgeport, CT, 06605-1601, US

(21) Appl. No.: 10/312,894

(22) PCT Filed: Dec. 12, 2001
(86) PCT No.: PCT/KR01/02150

(30) Foreign Application Priority Data
May 9, 2001 (KR) 2001/27537

(51) Int. Cl. G06F 15/16; G06F 15/173

(52) U.S. Cl. 709/224; 709/203; 709/229

(57) ABSTRACT

A system of tracking a cracker includes a web agent inserted in a predetermined web page; a location indicating unit for indicating an access location information of the user by analyzing a HTTP header; a comparing unit for comparing the location information of the user obtained by analyzing the HTTP header to location information of the user obtained by the web agent; and tracing unit for retrieving an original location of the user using the location information obtained by the web agent, wherein the web agent is downloaded to a computer of the user and transfers the location information of the user.

### BACKGROUND OF THE INVENTION

1. Field of the Invention

The present invention relates to the field of computer security, and more particularly to a system and method for the prevention of unauthorized intrusion into computer networks and systems.

2. Description of Related Art

Due to the spread of the Internet, it has now become possible to login to a remote computer or transfer files to a remote computer. It has also become possible to utilize services such as an electronic mall and a world wide web. On the other hand, in the Internet, the construction of protocols and systems with due consideration to security is delaying so that there are possibilities for illegal conducts such as stealing of secret information or deletion of important files by a malicious user who sneaks into a computer of a remote network, and wiretapping of communication data.

In order to deal with such illegal conducts, a security system such as an intrusion detection system (IDS) and a firewall or security gateway is often constructed in a network of an organization such as a company. The intrusion detection system provides a function to detect and control an intrusion of unauthorized users (e.g., cracker) in real-time. The firewall cuts off an access or intrusion of unauthorized user constructively.

However, the intrusion detection system and the firewall have problems in that they are performed using an information obtained by analyzing a packet on the network. For example, in case that the cracker who hides her/his information tries to access a web server, only HTTP information other than an original location information of the cracker can be identified by the intrusion detection system and the firewall.

Access records of all web servers are currently made using the HTTP information. When the cracker tries to access using a proxy server or an intermediate point, information of the proxy server or the intermediate point other than an original location information of the cracker is recorded in the web server. Therefore, it is almost impossible to trace the cracker using the proxy server information or the intermediate point information. Even though a location information of the intermediate point is identified, it requires a high expense and a long time to trace the cracker.

FIG. 1 shows a typical proxy server setting screen according. The web browser can be set to access the web server via the proxy server as shown in FIG. 1. In general, a person who writes an illegal content on an electronic bulletin board or a first page of a data resource in web site using a user information as an information to identify a user hides his/her information by nature. For example, when a user hides his/her information using the proxy server to make a composition or upload a data, an original location of the user cannot be identified because the HTTP information is recorded as shown in FIG. 2.

FIG. 3 shows an access log of an Apache server according to a conventional art, and FIG. 4 shows an error log of an Apache server according to a conventional art. As can be seen in FIGS. 3 and 4, since only the proxy server address is recorded in the web server, an original location of the cracker cannot be identified by the conventional security system.

For the foregoing reason, there is an urgent need for a cracker tracking system which can identify an original location of the cracker.

### SUMMARY OF THE INVENTION

To overcome the problems described above, preferred embodiments of the present invention provide a cracker tracing system and method which can identify an original location of a cracker.

It is another object of the present invention to provide an authentication system and method using a cracker tracing system which can identify an original location of a cracker.

In order to achieve the above object, the preferred embodiments of the present invention provide a system of tracking a cracker, comprising: a web agent inserted in a predetermined web page; a location indicating unit for indicating an access location information of the user by analyzing a HTTP header; a comparing unit for comparing the location information of the user obtained by analyzing the HTTP header to location information of the user obtained by the web agent; and tracing unit for retrieving an original location of the user using the location information obtained by the web agent, wherein the web agent is downloaded to a computer of the user and transfers the location information of the user.

The present invention further provides a method of tracing a cracker, comprising: a) Inserting a web agent is inserted in a predetermined web page; b) analyzing a HTTP header; c) downloading the web agent to a user computer to transfer location information of the user computer; and d) comparing location information obtained by analyzing the HTTP header to the location information obtained by the web agent.

The method further includes retrieving a location of a user using the location information obtained by the web agent when the location information obtained by analyzing the HTTP header is not identical to the location information obtained by the web agent, and storing the location information obtained by analyzing the HTTP header and the location information obtained by the web agent in a data base.

The present invention further provides an authentication system, comprising: a cracker tracing system including: a web agent inserted in a predetermined web page and downloaded to a computer of the user to transfer the location information of the user; a location indicating unit for indicating an access location information of the user by analyzing a HTTP header; a comparing unit for comparing the location information of the user obtained by analyzing the HTTP header to location information of the user obtained by the web agent; and tracing unit for retrieving an original location of the user using the location information obtained by the web agent, wherein an access is allowed when the location information of the user obtained by analyzing the HTTP header is identical to location information of the user obtained by the web agent.

The present invention further provides an authentication method, comprising: a) Inserting a web agent is inserted in a predetermined web page; b) analyzing a HTTP header; c) downloading the web agent to a user computer to transfer location information of the user computer; d) comparing location information obtained by analyzing the HTTP header to the location information obtained by the web agent; and e) allowing an access when the location information obtained by analyzing the HTTP header is identical to the location information obtained by the web agent.

The web agent is inserted in an error page and is downloaded to the computer of the user when an error occurs. The web agent includes a JAVA applet. The location information of the user obtained by the web agent includes an access time, an IP address, a host name, an error number, an access location, a URL option, a web browser information, and an operating system information. The comparing unit includes a JAVA program of a JSP server.

The present invention has the following advantages. Even though the cracker accesses the web server using the proxy server and the intermediate point, an original location of the cracker can be identified, and therefore it becomes possible to efficiently prevent unauthorized intrusion into computer networks and systems.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 shows a typical proxy server setting screen according to a conventional art;

FIG. 2 shows a proxy server address remaining when a composition is made on a board according to a conventional art;

FIG. 3 shows an access log of an Apache server according to a conventional art;

FIG. 4 shows an error log of an Apache server according to a conventional art;

FIG. 5 is a block diagram illustrating a cracker tracing system according to the present invention;

FIG. 6 shows an error page which automatically connects to a web page including a web agent according to the present invention;

FIG. 7 shows a web page source including the web agent according to the present invention;

FIG. 8 shows an error page displayed on a web browser according to the present invention;

FIGS. 9 and 10 show location information of the user obtained by the web agent and location information obtained by analyzing the HTTP header according to the present invention;

FIG. 11 shows a comparing routine for comparing the internet address and the host name of the user transferred by the web agent to those included in the HTTP header according to the present invention;

FIG. 12 shows information of the user computer obtained by the comparing unit according to the present invention;

FIG. 13 shows a resulting screen retrieved by a whois service according to the present invention;

FIG. 14 shows a proxy server list according to the present invention;

FIG. 15 is a flow chart illustrating a cracker tracing method according to the present invention; and

FIG. 16 is a flow chart illustrating an authentication method using the cracker tracing system according to the present invention.

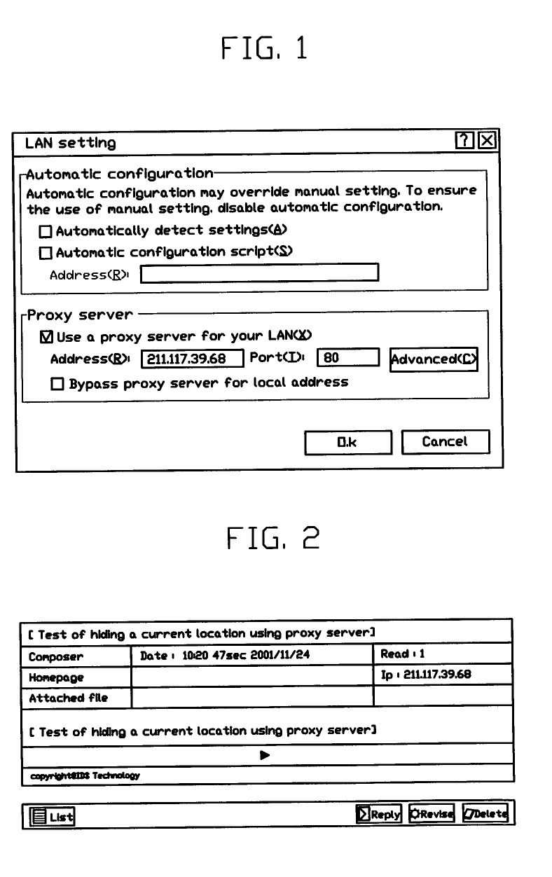

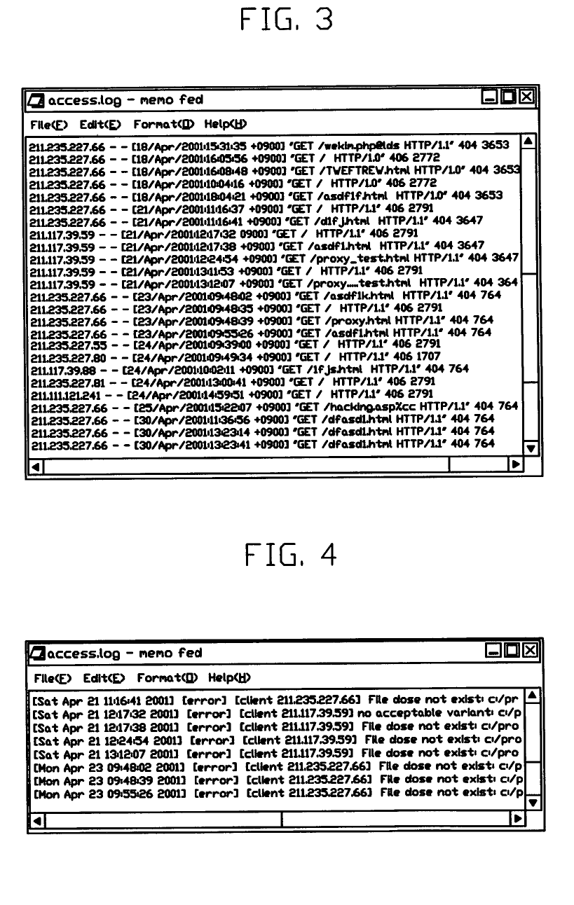

### DETAILED DESCRIPTION OF PREFERRED EMBODIMENTS

Reference will now be made in detail to preferred embodiments of the present invention, example of which is illustrated in the accompanying drawings.

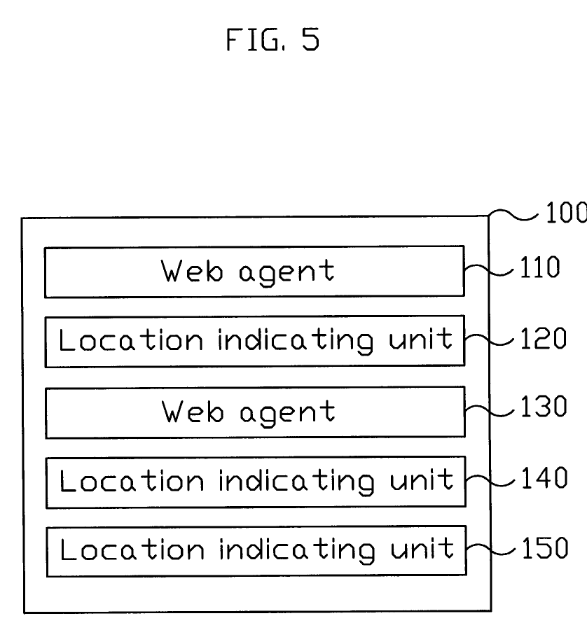

Turning now to the drawings, FIG. 5 is a block diagram illustrating a cracker tracing system according to the present invention.

Referring to FIG. 5, the cracker tracing system 100 includes a web agent 110, a location indicating unit 120, a comparing unit 130, a tracing unit 140, and a data base 150.

The web agent 110 is inserted in an error page. This is because an error may be caused while an unauthorized cracker analyzes a vulnerability of a web server or an error may occur when an unauthorized cracker adds an option to a currently contacting location so as to use a vulnerability or a bug of, e.g., a personal home page (PHP), a common gateway interface (CGI), an active server page (ASP), or a JAVA server page (JSP).

A representative web server includes an internet information server (IIS) and an Apache. In case of the IIS, an error page path is set such that a directory of an error page is set by fixing a bug of a user information in a registration information of an internet information service. In case of the Apache, an error page path can be set in “httpd.conf” under a path “/apache/htdocs/conf/.” In case of other web servers, the web agent 110 can be inserted in an error page by setting an error page configuration.

The web agent 110 can also be inserted in other pages desired by a server administrator, e.g., an authentication page, an electronic bulletin board or a first page of a data resource.

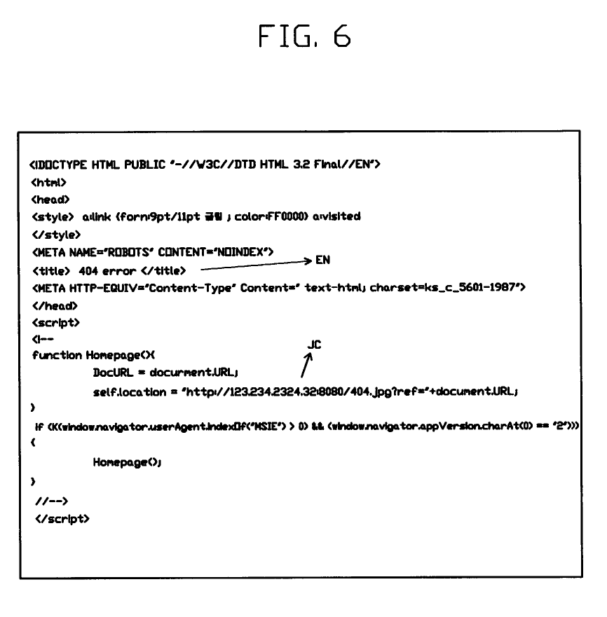

FIG. 6 shows a web page source (i.e., error page) which automatically connects to a web page including the web agent 110. All error pages are replaced in the form similar to the error page of FIG. 6. An error page number EN is set to a title. The HTML error page of FIG. 6 is automatically connected to a web page source including the web agent 110 by a JAVA script command JC.

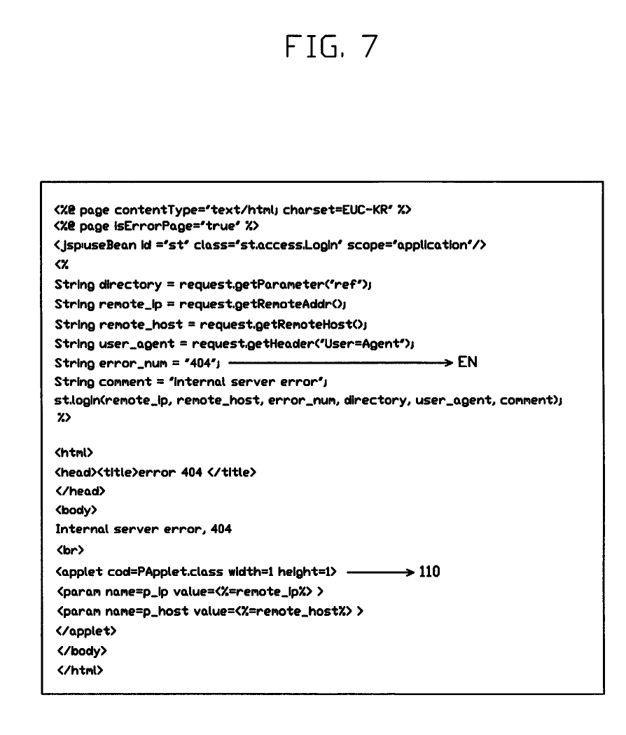

FIG. 7 shows a web page source including the web agent 110. The JSP error page including the web agent made of a JAVA applet is downloaded to a computer of the user. In other words, the web agent 110 is downloaded to a computer of the cracker when a user who tries to access causes an error. This is because the JAVA applet has an attribute which is downloaded to the computer of the user and is automatically executed by a JAVA virtual machine (JVM) of a web browser.

The web agent 110 downloaded to the computer of the user opens a socket and transfers a location information of the user computer such as an internet address and a host name to the agent server made of a JAVA. Transferred data by the web agent 110 are stored in the data base 150 which supports a JDBC driver via a JAVA database connectivity (JDBC).

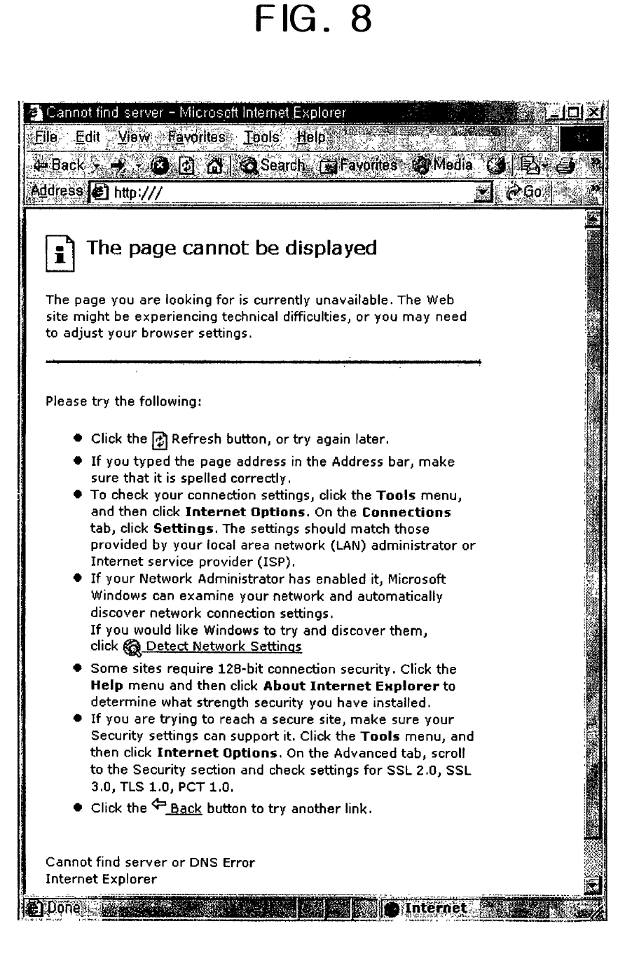

The web agent 110 can be programmed to disappear after transferring a location information of the user computer. At this moment, since only the error page of FIG. 8 is displayed on the web browser, the user cannot recognize operation of the web agent 110 which is performed in his/her computer.

The location indicating unit 120 analyzes a HTTP header to extract information such as an internet address and a host name.

The agent server stores location information contained in the HTTP header in the data base 150.

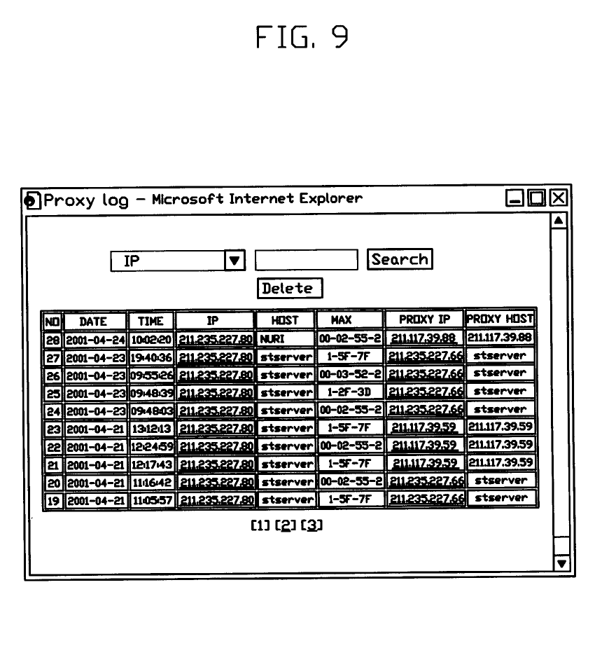

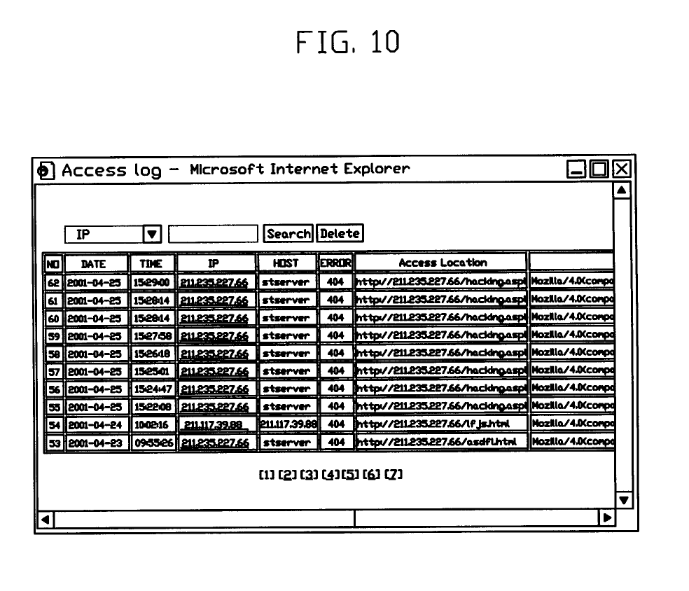

FIGS. 9 and 10 show location information of the user obtained by the web agent and location information obtained by analyzing the HTTP header. An access time, an IP address, a host name, an error number, an access location, a URL option, a web browser information, and an operating system information are stored in the data base 150 and are shown to a server administrator. The web agent further transfers a media access control (MAC) information to the agent server and stores it in the data base portion 150. The MAC information is a LAN card information recorded in a LAN card mounted in the user computer and can never be changed. The MAC information can be used as cracking corroborative facts. In order to obtain the MAC information, a request for the MAC address is sent to the user IP using a network basic input/output system (NETBIOS).

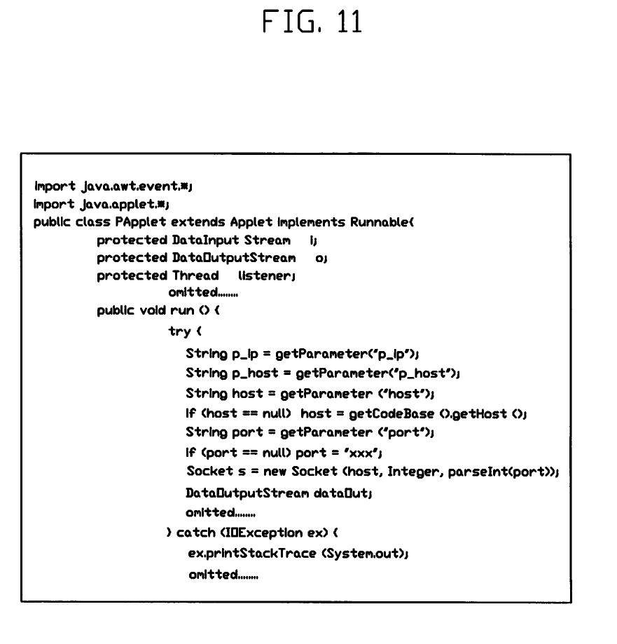

The comparing unit 130 (e.g., a JAVA program of a JSP server) compares the internet address and the host name of the user transferred by the web agent 110 to those included in the HTTP header. FIG. 11 shows a comparing routine for comparing the internet address and the host name of the user transferred by the web agent 110 to those included in the HTTP header. When the internet address and the host name of the user transferred by the web agent are identical to those included in the HTTP header, the user is regarded as an authorized accessor; otherwise, the user is regarded as an unauthorized cracker who hides his/her original location.

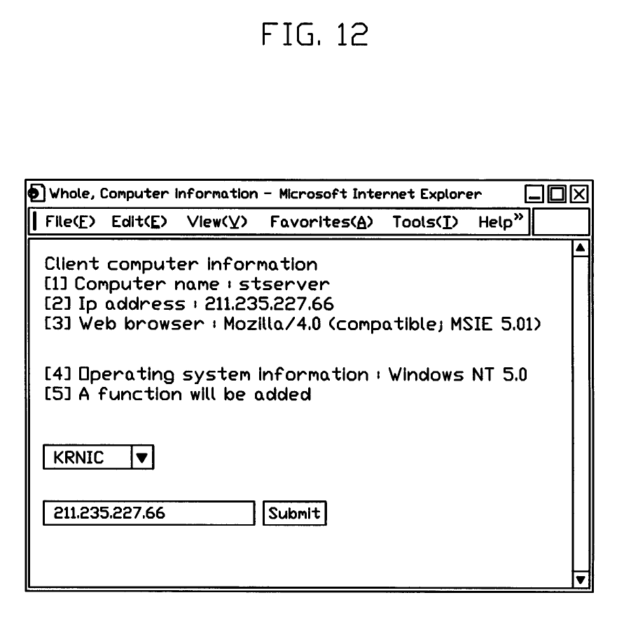

FIG. 12 shows information of the user computer obtained by the comparing unit 130. The operating system (OS) and the web browser information are obtained using the HTTP information. The internet address used to trace an original location of the user, i.e., cracker is obtained by the web agent 110. The operating system information and the web browser information obtained by analyzing the HTTP header and the internet address and the host name obtained by the web agent 110 can be used as vouchers or tracing data.

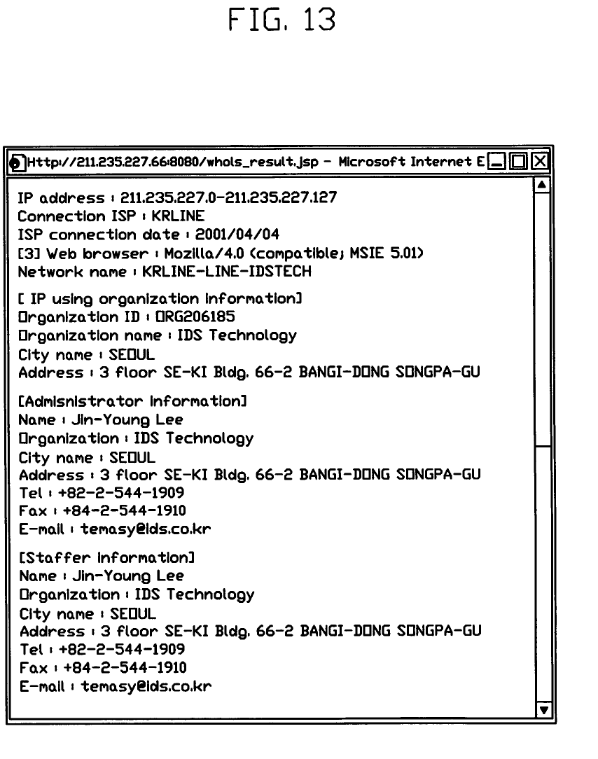

The tracing unit 140 retrieves an original internet address of the cracker using, e.g., a whois service using the internet address obtained by the web agent 110. FIG. 13 shows a resulting screen retrieved by the whois service.

The cracker who hides his/her location information continuously is stored as a blacklist in the database 150 and is shown to the server administrator.

The server administrator can retrieve an internet address which causes a continuous error using an error log recorded in the database 150 to find which vulnerability the cracker attacks using the web server access URL of the retrieved internet address.

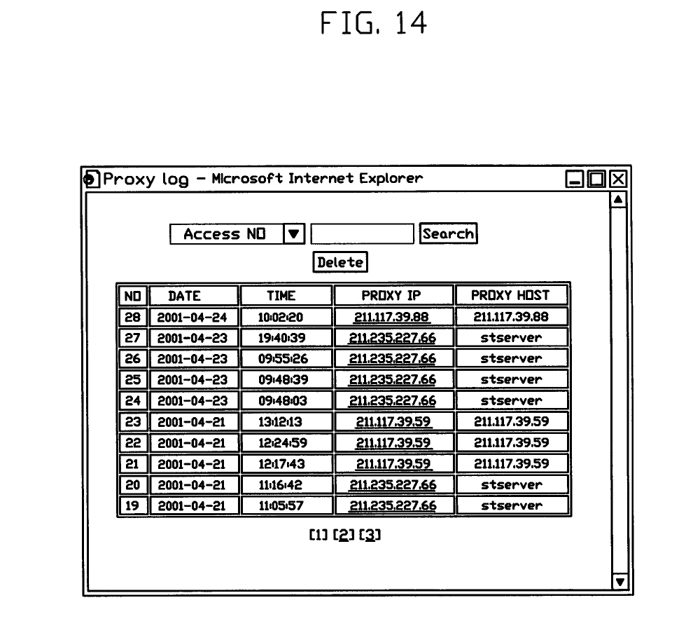

The server administrator can have a proxy server list as shown in FIG. 14 and thus find which proxy server the cracker uses mainly.

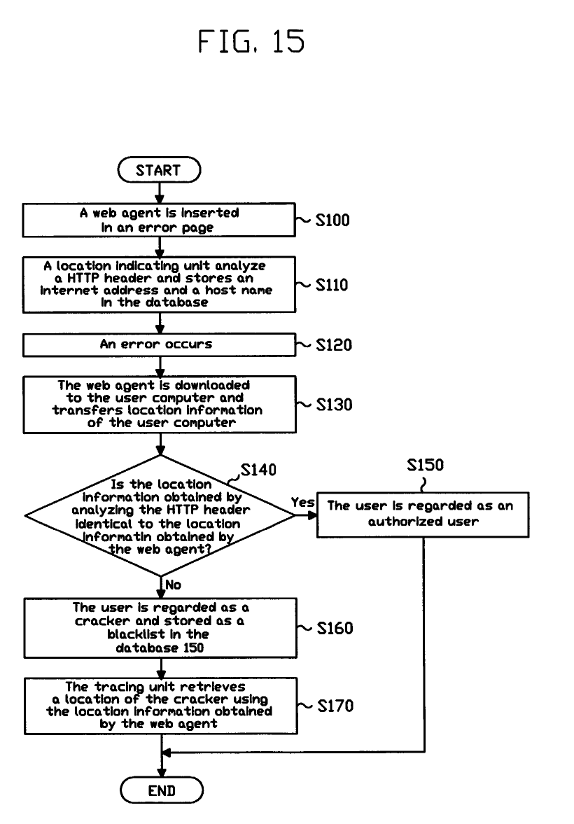

FIG. 15 is a flow chart illustrating a cracker tracing method according to the present invention.

The web agent is inserted in a web page (e.g., error page) desired by the server administrator (step S100). When a user accesses the web server, the location indicating unit 120 analyze the HTTP header and stores an internet address and a host name in the database 150 (step S110). When an error occurs (step S120), the web agent 110 is downloaded to the user computer together with the error page and transfers location information of the user computer such as an internal address and a host name (step S130). The location of the user computer is stored in the database 150. The comparing unit 130 compares the location information obtained by analyzing the HTTP header to the location information obtained by the web agent (step S140). When the location information obtained by analyzing the HTTP header is identical to the location information obtained by the web agent, the user is regarded as an authorized user (step S150). When the location information obtained by analyzing the HTTP header is not identical to the location information obtained by the web agent, the user is regarded as a cracker and stored as a blacklist in the database 150 (step S160). The location of the cracker is retrieved by the tracing unit 140 such as a whois service using the location information obtained by the web agent (step S170).

The cracker tracing system and method described above can be applied to various industrial fields.

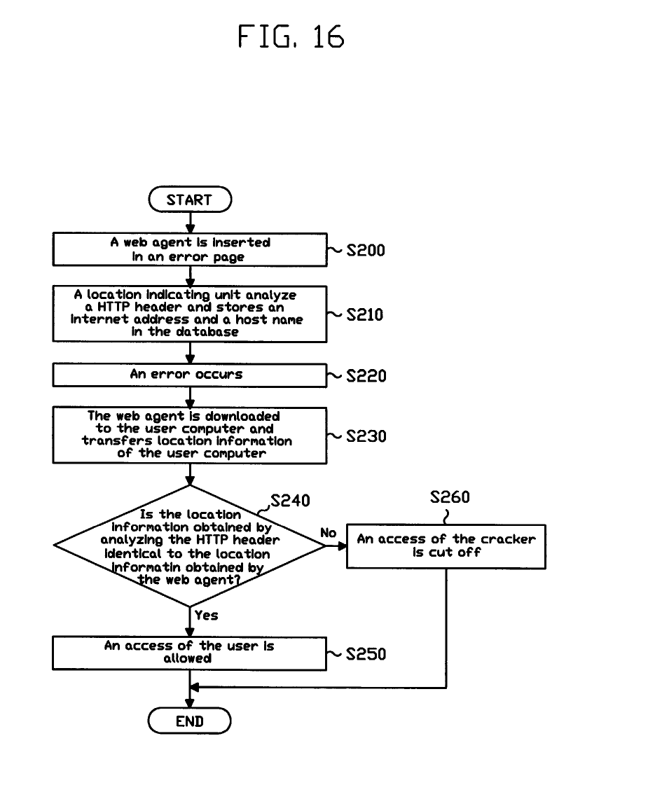

FIG. 16 is a flow chart illustrating an authentication method using the cracker tracing system according to the present invention. Steps S200 to Step S240 of FIG. 16 are the same as the steps S100 to S140, and therefore their description is omitted to avoid a redundancy.

When the location information obtained by analyzing the HTTP header is identical to the location information obtained by the web agent, the user is regarded as an authorized user. Therefore, an access of the user is allowed after a predetermined authentication method (step S250). However, when the location information obtained by analyzing the HTTP header is not identical to the location information obtained by the web agent, the user is regarded as a cracker and stored as a blacklist in the database 150. Therefore, access of the cracker is cut off and the error page is output (step S260).

As described herein before, using the cracker tracing system and method and the authentication system and method, even though the cracker accesses the web server using the proxy server and the intermediate point, an original location of the cracker can be identified, and therefore it becomes possible to efficiently prevent unauthorized intrusion into computer networks and systems.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A system of tracking a cracker, comprising:
a web agent inserted in a predetermined web page;
a location indicating unit for indicating an access location information of the user by analyzing a HTTP header;
a comparing unit for comparing the location information of the user obtained by analyzing the HTTP header to location information of the user obtained by the web agent; and
tracing unit for retrieving an original location of the user using the location information obtained by the web agent,
wherein the web agent is downloaded to a computer of the user and transfers the location information of the user.

2. The system of claim 1, wherein the web agent is inserted in an error page and is downloaded to the computer of the user when an error occurs.

3. The system of claim 1, wherein the web agent includes a JAVA applet.

4. The system of claim 1, further comprising, a database for storing the location information of the user obtained by analyzing the HTTP header and the location information of the user obtained by the web agent.

5. The system of claim 1, wherein the location information of the user obtained by the web agent includes an access time, an IP address, a host name, an error number, an access location, a URL option, a web browser information, an operating system information, and a MAC information.

6. The system of claim 1, wherein the comparing unit includes a JAVA program of a JSP server.

7. A method of tracing a cracker, comprising:
a) Inserting a web agent is inserted in a predetermined web page;
b) analyzing a HTTP header;
c) downloading the web agent to a user computer to transfer location information of the user computer; and
d) comparing location information obtained by analyzing the HTTP header to the location information obtained by the web agent.

8. The method of claim 7, further comprising, retrieving a location of a user using the location information obtained by the web agent when the location information obtained by analyzing the HTTP header is not identical to the location information obtained by the web agent.

9. The method of claim 7, further comprising, storing the location information obtained by analyzing the HTTP header and the location information obtained by the web agent in a data base.

10. The method of claim 7, wherein the web agent is inserted in an error page and is downloaded to the computer of the user when an error occurs.

11. The method of claim 7, wherein the web agent includes a JAVA applet.

12. The method of claim 7, wherein the location information of the user obtained by the web agent includes an access time, an IP address, a host name, an error number, an access location, a URL option, a web browser information, an operating system information, and a MAC information.

13. The method of claim 7, wherein the step of (d) is performed by a JAVA program of a JSP server.

14. An authentication system, comprising:
a cracker tracing system including:
a web agent inserted in a predetermined web page and downloaded to a computer of the user to transfer the location information of the user;
a location indicating unit for indicating an access location information of the user by analyzing a HTTP header;
a comparing unit for comparing the location information of the user obtained by analyzing the HTTP header to location information of the user obtained by the web agent; and
a tracing unit for retrieving an original location of the user using the location information obtained by the web agent,
wherein an access is allowed when the location information of the user obtained by analyzing the HTTP header is identical to location information of the user obtained by the web agent.

15. The system of claim 14, wherein the web agent is inserted in an error page and is downloaded to the computer of the user when an error occurs.

16. The system of claim 14, wherein the web agent includes a JAVA applet.

17. The system of claim 14, further comprising, a database for storing the location information of the user obtained by analyzing the HTTP header and the location information of the user obtained by the web agent.

18. The system of claim 14, wherein the location information of the user obtained by the web agent includes an access time, an IP address, a host name, an error number, an access location, a URL option, a web browser information, an operating system information, and a MAC information.

19. The system of claim 14, wherein the comparing unit includes a JAVA program of a JSP server.

20. An authentication method, comprising:
a) Inserting a web agent is inserted in a predetermined web page;
b) analyzing a HTTP header;
c) downloading the web agent to a user computer to transfer location information of the user computer;
d) comparing location information obtained by analyzing the HTTP header to the location information obtained by the web agent; and
e) allowing an access when the location information obtained by analyzing the HTTP header is identical to the location information obtained by the web agent.

21. The method of claim 20, further comprising, retrieving a location of a user using the location information obtained by the web agent when the location information obtained by analyzing the HTTP header is not identical to the location information obtained by the web agent.

22. The method of claim 20, further comprising, storing the location information obtained by analyzing the HTTP header and the location information obtained by the web agent in a data base.

23. The method of claim 20, wherein the web agent is inserted in an error page and is downloaded to the computer of the user when an error occurs.

24. The method of claim 20, wherein the web agent includes a JAVA applet.

25. The method of claim 20, wherein the location information of the user obtained by the web agent includes an access time, an IP address, a host name, an error number, an access location, a URL option, a web browser information, an operating system information, and a MAC information.

26. The method of claim 20, wherein the step of (d) is performed by a JAVA program of a JSP server.

27. The system of claim 1, wherein the MAC information is obtained by sending a request for a MAC address to the IP address of the user using a NETBIOS.

28. The method of claim 12, wherein the MAC information is obtained by sending a request for a MAC address to the IP address of the user using a NETBIOS.

29. The system of claim 18, wherein the MAC information is obtained by sending a request for a MAC address to the IP address of the user using a NETBIOS.

30. The method of claim 25, wherein the MAC information is obtained by sending a request for a MAC address to the IP address of the user using a NETBIOS.
